(19) United States
(12) Patent Application Publication
(10) Pub. No.: US 2016/0221110 A1
(43) Pub. Date: Aug. 4, 2016

(54) RESISTANCE SPOT WELDING APPARATUS, COMPOSITE ELECTRODE, AND RESISTANCE SPOT WELDING METHOD

(71) Applicant: NIPPON STEEL & SUMITOMO METAL CORPORATION, Tokyo (JP)

(72) Inventors: Tohru OKADA, Toyota-shi, Aichi (JP); Yoshiaki NAKAZAWA, Takarazuka-shi, Hyogo (JP); Yasuhiro ITO, Amagasaki-shi (JP); Masanori YASUYAMA, Kobe-shi, Hyogo (JP)

(21) Appl. No.: 15/021,950

(22) PCT Filed: Sep. 22, 2014
(86) PCT No.: PCT/JP2014/004846

§ 371 Date: Mar. 15, 2016

(30) Foreign Application Priority Data
Sep. 25, 2013 (JP) 2013-197814

(51) Int. Cl. B23K 11/30; B23K 11/11

(52) U.S. Cl. CPC B23K 11/3009; B23K 11/115

(57) ABSTRACT

A resistance spot welding apparatus for performing resistance spot welding on a sheet set including a plurality of lapped metal sheets includes a pair of composite electrodes facing each other so as to hold the sheet set therebetween. The composite electrodes each include: a rod-shaped electrode body having an end surface that is brought into contact with and pressed against the sheet set; an electrically conductive rigid body having a through hole in which the electrode body is inserted and having an end surface that is brought into contact with and pressed against the sheet set; and a resilient member coupled to a rear end of the rigid body, the resilient member configured to apply a pressing force to the rigid body as the electrode body and the rigid body are pressed against the sheet set.

### TECHNICAL FIELD

The present invention relates to technologies of resistance spot welding and in particular to a resistance spot welding apparatus for performing welding on a sheet set including a plurality of lapped metal sheets. Furthermore, the present invention relates to a composite electrode and a resistance spot welding method that are used in the resistance spot welding.

### BACKGROUND ART

Transportation machines such as automobiles and industrial machines include a plurality of structural parts. Resistance spot welding (hereinafter also simply referred to as “spot welding”) is utilized in production of structural parts in many cases.

In general, spot welding is performed in the following manner. A sheet set is prepared as a workpiece. The sheet set includes a portion in which a plurality of metal sheets are lapped. Next, the sheet set is clamped by a pair of electrodes and the electrodes are pressed against the sheet set. Then, a current is applied across the electrodes while the forces by the pressing of the electrodes are being applied to the sheet set. Thus, in the sheet set, the forces applied by the electrodes bring adjacent metal sheets into contact with each other and the current flows through the contact area and nearby areas. The areas are melted by Joule heating due to the electrical resistance and then solidify to form a nugget. By means of the formation of a nugget, the metal sheets in the sheet set are joined and connected together, whereby structural parts are produced.

Examples of the electrodes that may be used include a flat type electrode tip, a DR (double R) type electrode tip, and an SR (single R) type electrode tip. Flat type electrode tips have a columnar shape with a flat end surface. DR type electrode tips have a substantially columnar shape with an end portion projecting in a convex shape in which the end surface is a convex curved surface having a large radius of curvature. SR type electrode tips have a substantially columnar shape with an end surface which is a convex curved surface having a large radius of curvature.

In recent years, there has been an increasing trend toward use of light weight structural parts, and thus the metal sheets constituting the sheet set are often high tensile strength steels, so-called high tensile steels. High tensile steels, particularly high tensile steels having a tensile strength of 590-780 MPa Grade or higher grade (hereinafter also referred to as “super high tensile steels”) are less prone to plastic deformation and have a high electrical resistance.

According to such material properties as described, in spot welding of a super high tensile steel, the suitable range of the welding current to be applied to the electrodes (hereinafter also referred to as “suitable current range”) tends to be narrower. The term “suitable current range” refers to a range of current values from the minimum current value required to obtain a nominal nugget diameter, which is set according to the design specification, to the maximum current value up to which no expulsion occurs. As the suitable current range expands, the advantages increase in ensuring stable operation of spot welding and achieving the nugget diameter.

In addition, when a super high tensile steel is spot welded, enhancement of the joint strength is difficult to achieve. For example, in the case of a base metal (high tensile steel) having a tensile strength exceeding the range of 590 to 780 MPa, the tensile strength in the peeling direction, i.e., the so-called cross tension strength (CTS), which is one of the weld joint strength criteria, tends to decrease rather than increase.

Thus, spot welding of super high tensile steels involves the problems of a narrower suitable current range and a decrease in CTS, and therefore there is a requirement for expansion of the suitable current range and increase of the weld joint strength.

To expand the suitable current range, one possible technique is to increase the force applied by the electrodes when pressing them against the sheet set and another possible technique is to perform multi-stage current applications when applying the current across the electrodes. However, increasing the applied force has its limitations in association with the stiffness of the apparatus. Also, multi-stage current applications result in increased welding time and thus decreased productivity. Hence, neither of these techniques is practical.

To increase the weld joint strength, one possible technique is to perform additional, subsequent heating after formation of the nugget and another possible technique is to enlarge the nugget diameter. Subsequent heating tempers and softens the formed nugget to thereby improve its toughness. As a result, the weld joint strength increases. However, performing subsequent heating results in increase of welding time and thus decrease of productivity. Hence, subsequent heating is not practical.

Enlargement of the nugget diameter effectively contributes to increasing the weld joint strength. This is because, as the nugget diameter increases, the weld joint strength increases. To enlarge the nugget diameter, one possible technique is to perform multi-stage applications of the current across the electrodes and another possible technique is to increase the diameter of the electrode end surface. However, the multi-stage current application process is a process in which the nugget growth progresses gradually, which results in increased welding time and thus decreased productivity. Hence, the multi-stage current application process is not practical.

Increase of the electrode end diameter poses the following problems. When a flat type electrode tip is employed as the electrode, for example, the extended flat end surface needs to be uniformly contacted with the sheet set. For this reason, extremely high dimensional accuracy is required for the flatness of the electrode end surface. On the other hand, when a DR type electrode tip is employed as the electrode, it is necessary to press the extended convex curved end surface deeply into the sheet set so that it is in contact over the entire area. However, an increased amount of pressing leads to the occurrence of sheet separation to limit the current paths, and therefore enlargement of the nugget diameter is limited. Accordingly, for flat type electrode tips, DR type electrode tips, and the like, simply increasing the electrode end diameter is not deemed to be practical.

As opposed to these approaches, a technique to enlarge the nugget diameter from a different point of view is proposed in Japanese Patent Application Publication No. 2012-55896 (Patent Literature 1). Patent Literature 1 discloses a resistance spot welding apparatus including: a pair of main electrodes facing each other so as to hold a sheet set therebetween; and an annular auxiliary electrode disposed so as to surround one of the main electrodes (hereinafter also referred to as “first main electrode” for convenience of description). According to the technique disclosed in Patent Literature 1, the auxiliary electrode has a polarity opposite to the polarity of the first main electrode, and currents are applied across the pair of main electrodes and across the first main electrode and the auxiliary electrode. Accordingly, currents flow between the main electrodes and also between the first main electrode and the auxiliary electrode.

In the case where the thickness of the metal sheet with which the first main electrode and the auxiliary electrode are brought into contact is thin, the current flows over a large region in the contact area between the thin metal sheet and an adjoining metal sheet because the contact area is located close to the first main electrode and the auxiliary electrode. Consequently, a nugget having a large nugget diameter is formed, according to Patent Literature 1.

However, the technique disclosed in Patent Literature 1 is unable to increase the nugget diameter in the case where the thickness of the metal sheet with which the first main electrode and the auxiliary electrode are brought into contact is large. The reason is that the application range of the current that flows in the contact area cannot be extended because the contact area, which is positioned between the thick metal sheet and an adjoining metal sheet, is located away from the first main electrode and the auxiliary electrode.

### CITATION LIST

### Patent Literature

Patent Literature 1: Japanese Patent Application Publication No. 2012-55896

### SUMMARY OF INVENTION

### Technical Problem

As described above, in spot welding of a super high tensile steel, there is a requirement for expansion of the suitable current range and increase of the weld joint strength. However, none of the techniques described above are practical. Furthermore, while enlargement of the nugget diameter is effective at increasing the weld joint strength, even the technique disclosed in Patent Literature 1 cannot achieve sufficient enlargement of the nugget diameter.

An object of the present invention is to provide a resistance spot welding apparatus, composite electrode, and resistance spot welding method having the following characteristics:

Expansion of the suitable current range in spot welding of a super high tensile steel is achieved; and

Increase of the weld joint strength in spot welding of a super high tensile steel is achieved.

### Solution to Problem

A resistance spot welding apparatus according to an embodiment of the present invention is an apparatus for performing resistance spot welding on a sheet set including a plurality of lapped metal sheets, the apparatus including a pair of composite electrodes facing each other so as to hold the sheet set therebetween. The composite electrodes each include: a rod-shaped electrode body having an end surface that is brought into contact with the sheet set and pressed against the sheet set; a rigid body including an electrically conductive material being insulated from the electrode body, the rigid body having a through hole in which the electrode body is inserted and having an end surface that is brought into contact with the sheet set and pressed against the sheet set; and a resilient member coupled to a rear end of the rigid body, the resilient member configured to apply a pressing force to the rigid body as the electrode body and the rigid body are pressed against the sheet set.

In the above resistance spot welding apparatus, at least part of the end surface of the rigid body may include an electrically conductive material.

In the above resistance spot welding apparatus, the rigid body preferably has a cylindrical shape. The rigid body may be configured such that an inner periphery of the end surface is circular and an outer periphery of the end surface is oval, elliptical, or substantially rectangular.

In the above resistance spot welding apparatus, the resilient member may be a compression coil spring or the resilient member may be a cylindrical molded polymeric component.

In any of the above resistance spot welding apparatuses, a spacing between an outer periphery of the end surface of the electrode body and an inner periphery of the end surface of the rigid body is preferably at most 7 mm

The above resistance spot welding apparatuses each preferably include a cooling mechanism that cools the rigid body.

A composite electrode according to an embodiment of the present invention is a composite electrode for use in resistance spot welding of a sheet set including a plurality of lapped metal sheets, the composite electrode including: a rod-shaped electrode body having an end surface that is brought into contact with the sheet set and pressed against the sheet set; a rigid body including an electrically conductive material being insulated from the electrode body, the rigid body having a through hole in which the electrode body is inserted and having an end surface that is brought into contact with the sheet set and pressed against the sheet set; and a resilient member coupled to a rear end of the rigid body, the resilient member configured to apply a pressing force to the rigid body as the electrode body and the rigid body are pressed against the sheet set.

In the above composite electrode, at least part of the end surface of the rigid body may include an electrically conductive material.

In the above composite electrode, the rigid body preferably has a cylindrical shape. The rigid body may be configured such that an inner periphery of the end surface is circular and an outer periphery of the end surface is oval or substantially rectangular.

In the above composite electrode, the resilient member may be a compression coil spring or the resilient member may be a cylindrical molded polymeric component.

In any of the above composite electrodes, a spacing between an outer periphery of the end surface of the electrode body and an inner periphery of the end surface of the rigid body is preferably at most 7 mm

The above composite electrodes each preferably include a cooling mechanism that cools the rigid body.

A resistance spot welding method according to an embodiment of the present invention is a method for performing resistance spot welding on a sheet set including a plurality of lapped metal sheets, the method including a series of steps including a first step, a second step, and a third step. The first step includes: arranging a rod-shaped first electrode body and a rod-shaped second electrode body to face each other with the sheet set interposed therebetween; and arranging a first rigid body including an electrically conductive material and a second rigid body including an electrically conductive material to face each other with the sheet set interposed therebetween, the first rigid body having a through hole in which the first electrode body is inserted and having a rear end to which a first resilient member is coupled, the second rigid body having a through hole in which the second electrode body is inserted and having a rear end to which a second resilient member is coupled. The second step includes applying a force to the sheet set by: pressing the end surface of the first electrode body and the end surface of the second electrode body against the sheet set; and pressing the end surface of the first rigid body and the end surface of the second rigid body against the sheet set while a pressing force from the first resilient member is being applied to the first rigid body and a pressing force from the second resilient member is being applied to the second rigid body. The third step includes applying a current across the first electrode body and the second electrode body while applying the force to the sheet set.

### Advantageous Effects of Invention

A resistance spot welding apparatus, composite electrode, and resistance spot welding method of the present invention have significant advantages such as the following:

Expansion of the suitable current range in spot welding of a super high tensile steel can be achieved; and

Increase of the weld joint strength in spot welding of a super high tensile steel can be achieved.

### BRIEF DESCRIPTION OF DRAWINGS

FIG. 1 is a cross-sectional view of a sheet set used as a workpiece to which welding is to be applied;

FIG. 2A is a schematic diagram of a resistance spot welding apparatus according to a first embodiment, showing a state prior to welding;

FIG. 2B is a schematic diagram of the resistance spot welding apparatus according to the first embodiment, showing a state during welding;

FIG. 3 is a schematic diagram illustrating a situation in which a nugget is for lied by spot welding using the resistance spot welding apparatus shown in FIG. 2;

FIG. 4 is a graph showing the relationships between the electrode-to-rigid body spacing and the maximum nugget diameter and between the electrode-to-rigid body spacing and the suitable current range;

FIG. 5A is a schematic diagram of a resistance spot welding apparatus according to a second embodiment, showing a state prior to welding;

FIG. 5B is a schematic diagram of the resistance spot welding apparatus according to the second embodiment, showing a state during welding; and

FIG. 6 is a graph showing the results of a spot welding test in Example.

### DESCRIPTION OF EMBODIMENTS

Embodiments of the resistance spot welding apparatus, composite electrode, and resistance spot welding method of the present invention will be described in detail below.

The resistance spot welding apparatus of the present embodiment is utilized to perform spot welding on a sheet set including a plurality of lapped metal sheets. The composite electrode of the present embodiment is mounted to the spot welding apparatus and utilized in spot welding. The resistance spot welding method of the present embodiment is utilized in spot welding using the spot welding apparatus.

### First Embodiment

### 1. Configuration of the Resistance Spot Welding Apparatus and Composite Electrode

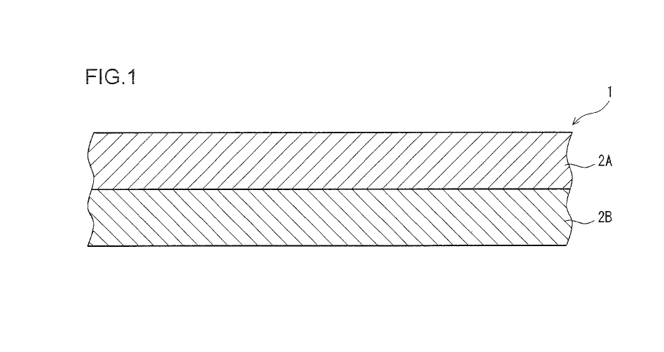

FIG. 1 is a cross-sectional view of a sheet set used as a workpiece to which welding is to be applied. As shown in FIG. 1, a sheet set 1 used as a workpiece in the present embodiment has a portion in which two metal sheets 2A, 2B are lapped over each other. Both of the metal sheets 2A, 2B are super high tensile steels having a tensile strength of 590-780 MPa Grade or higher grade. The metal sheets 2A, 2B each have a thickness of about 0.5 to 3 mm, and the thicknesses may be the same or different from each other.

Depending on the form of the structural part to be manufactured by the spot welding, the sheet set may have a portion in which three or more metal sheets are lapped over each other. The properties of the metal sheets are not limited as long as spot welding can be applied and therefore they may be a high tensile steel having a tensile strength lower than 590 MPa or may be a mild steel. Also, the presence or absence of coating, the type of coating, etc. are not limiting. The plurality of lapped metal sheets may be of the same metal or may be of dissimilar metals.

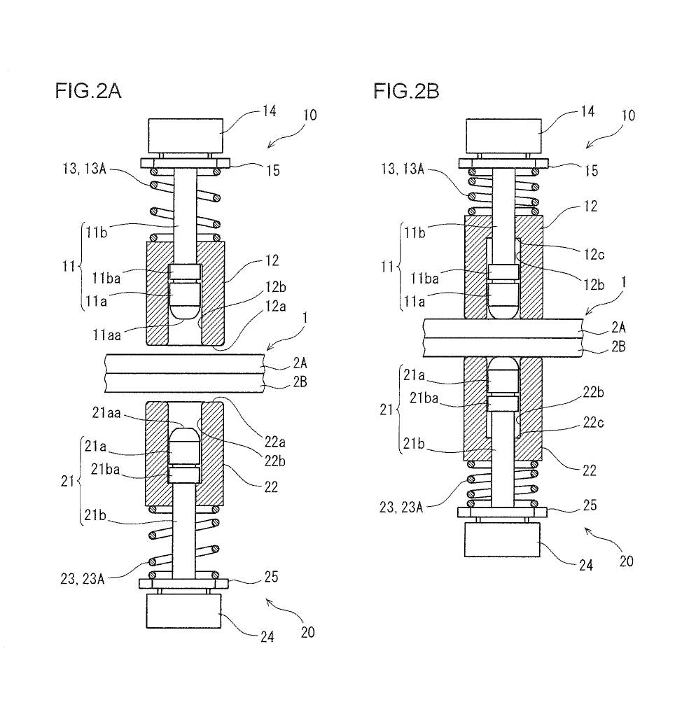

FIGS. 2A and 2B are schematic diagrams of a resistance spot welding apparatus according to a first embodiment. FIG. 2A shows a state prior to welding and FIG. 2B shows a state during welding. The spot welding apparatus shown in FIGS. 2A and 2B includes a pair of composite electrodes 10, 20. Hereinafter, for convenience of description, one of the composite electrodes 10, 20 (the upper composite electrode in FIGS. 2A and 2B) is also referred to as the first composite electrode 10, and the other (the lower composite electrode in FIGS. 2A and 2B) is also referred to as the second composite electrode 20. The first composite electrode 10 and the second composite electrode 20 are configured in the same manner and are arranged to face each other so as to hold the sheet set 1 therebetween. Specifically, the first composite electrode 10 includes a first electrode body 11 and a first rigid body 12, and the second composite electrode 20 includes a second electrode body 21 and a second rigid body 22.

The first electrode body 11 includes a straight, rod-shaped shank 11b and an electrode tip 11a attached to an end of the shank 11b, forming a rod shape as a whole. The shank 11b has a flange portion 11ba adjacent the electrode tip 11a. The electrode tip 11a is a DR type electrode tip. Specifically, the electrode tip 11a has a substantially columnar shape with an end portion projecting in a convex shape in which an end surface 11 as is a convex curved surface having a large radius of curvature. The electrode tip 11a may be a known electrode tip other than a DR type electrode tip, and therefore a flat type electrode tip, an SR type electrode tip, or the like may be employed. The shank 11b is secured at its rear end to a holder 14.

The first rigid body 12 is cylindrically shaped and has a circular through hole 12b about the central axis, and the first electrode body 11 is disposed concentrically with the through hole 12b. The electrode tip 11a and flange portion 11ba of the first electrode body 11 are inserted in the first rigid body 12 and are relatively movable along the axial length to an end surface 12a of the first rigid body 12. The first rigid body 12 has, at its rear end portion, a stopper surface 12c, with which the flange portion 11ba of the first electrode body 11 is brought into contact so as to prevent the first rigid body 12 from detaching from the first electrode body 11.

The first rigid body 12 and the fist electrode body 11 are insulated from each other without being electrically connected. Specifically, an insulator such as an engineering plastic is disposed in the region where the first rigid body 12 and the first electrode body 11 can be directly or indirectly connected to each other. For example, an insulator is disposed in a region where the shank 11b slides, among regions of the through hole 12b of the first rigid body 12.

A retainer plate 15 is secured to the front end of the holder 14. A compression coil spring 13A, employed as a first resilient member 13, is disposed between the rear end of the first rigid body 12 and the retainer plate 15. The shank 11b of the first electrode body 11 passes through the compression coil spring 13A (first resilient member 13) concentrically therewith. The first rigid body 12 is relatively movable along the shank 11b.

Likewise, the second electrode body 21 includes a straight, rod-shaped shank 21b and an electrode tip 21a attached to an end of the shank 21b, forming a rod shape as a whole. The shank 21b has a flange portion 21ba adjacent the electrode tip 21a. The electrode tip 21a is a DR type electrode tip. The shank 21b is secured at its rear end to a holder 24.

The second rigid body 22 is cylindrically shaped and has a circular through hole 22b about the central axis, and the second electrode body 21 is disposed concentrically with the through hole 22b. The electrode tip 21a and flange portion 21ba of the second electrode body 21 are accommodated in the second rigid body 22 and are relatively movable along the axial length to an end surface 22a of the second rigid body 22. The second rigid body 22 has, at its rear end portion, a stopper surface 22c, with which the flange portion 21ba of the second electrode body 21 is brought into contact so as to prevent the second rigid body 22 from detaching from the second electrode body 21.

The second rigid body 22 and the second electrode body 21 are insulated from each other without being electrically connected. Specifically, an insulator such as an engineering plastic is disposed in the region where the second rigid body 22 and the second electrode body 21 can be directly or indirectly connected to each other. For example, an insulator is disposed in a region where the shank 21b slides, among regions of the through hole 22b of the second rigid body 22.

A retainer plate 25 is secured to the front end of the holder 24. A compression coil spring 23A, employed as a second resilient member 23, is disposed between the rear end of the second rigid body 22 and the retainer plate 25. The shank 21b of the second electrode body 21 passes through the compression coil spring 23A (second resilient member 23) concentrically therewith. The second rigid body 22 is relatively movable along the shank 21b.

Examples of the material of the shanks 11b, 21b and electrode tips 11a, 11b, which constitute the first electrode body 11 and the second electrode body 21, include a copper-chromium alloy, a copper-chromium-zirconium alloy, a copper-beryllium alloy, an aluminum-oxide-dispersion-strengthened copper alloy, and a copper-tungsten alloy. The material of the first electrode body 11 and the second electrode body 21 is not particularly limited as long as they can form electrodes.

The first rigid body 12 and the second rigid body 22 are rigid bodies that do not deform under an external force, each including an electrically conductive material such as a metal. The end surfaces 12a, 22a of the first rigid body 12 and the second rigid body 22 may be formed entirely of an electrically conductive material or partially of an electrically conductive material.

The material of the first rigid body 12 and the second rigid body 22 is not particularly limited as long as it has a high electrical conductivity, and may be the same as the material of the first electrode body 11 and the second electrode body 21 or may be different. However, the material of the first rigid body 12 and the second rigid body 22 needs to have an electrical conductivity higher than the electrical conductivity of the sheet set (metal sheets) to be welded. This is intended to effectively draw the current that flows through the sheet set during spot welding into the first rigid body 12 and the second rigid body 22 as described in detail later.

The holders 14, 24 of the thus configured first composite electrode 10 and the second composite electrode 20 are attached to a spot welding gun (not shown). Specifically, the welding gun includes a pair of aims capable of opening and closing operation. The holder 14 of the first composite electrode 10 is attached to an end of one of the arms and the holder 24 of the second composite electrode 20 is attached to an end of the other of the arms. The opening and closing operation of the two arms causes the first composite electrode 10 and the second composite electrode 20 to be moved away from and close to each other. At this time, the first electrode body 11 and the second electrode body 21 are coaxially aligned to face each other and the first rigid body 12 and the second rigid body 22 are also coaxially aligned to face each other. Optionally, one of the pair of arms may be stationary.

The first electrode body 11 and the second electrode body 21 are connected to a power supply (not shown). For example, when a DC power supply is used as the power supply, the positive electrode of the power supply is connected to the first electrode body 11 and the negative electrode of the power supply is connected to the second electrode body 21. The connections to the positive electrode and the negative electrodes may be opposite. The power supply may alternatively be an AC power supply.

### 2. Resistance Spot Welding

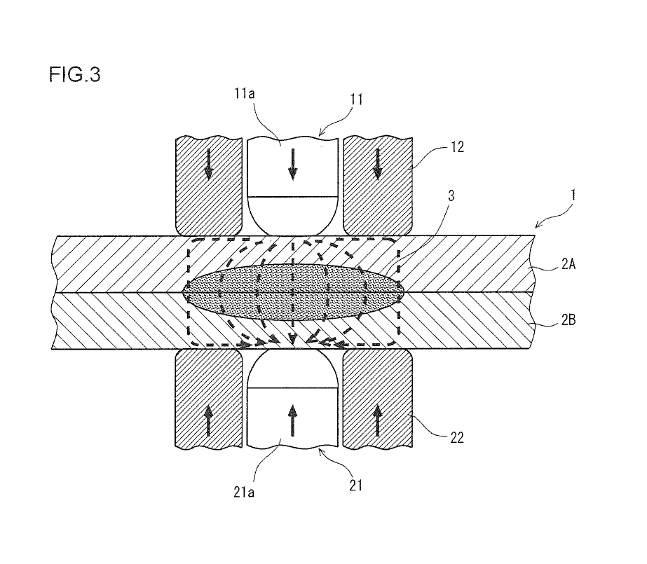

With reference to FIG. 2 described above and FIG. 3 described below, a process of spot welding using the spot welding apparatus of the present embodiment will be described.

Firstly, as shown in FIG. 2A, the sheet set 1 having a portion in which two metal sheets 2A, 2B are lapped over each other is prepared as a workpiece. Next, the first electrode body 11 of the first composite electrode 10 and the second electrode body 21 of the second composite electrode 20 are arranged to face each other with the sheet set 1 interposed therebetween, and the corresponding first rigid body 12 and second rigid body 22 are arranged to face each other with the sheet set 1 interposed therebetween. This operation is carried out by movement of the welding gun or by transfer of the sheet set 1.

Next, the operation of closing the two arms of the welding gun is carried out to begin the operation of pressing the first composite electrode 10 and the second composite electrode 20 against the sheet set 1. The operation causes the holder 14 to move toward the sheet set 1 in the first composite electrode 10 and simultaneously causes the holder 24 to move toward the sheet set 1 in the second composite electrode 20. Accordingly, in the first composite electrode 10, the end surface 12a of the first rigid body 12 is firstly brought into contact with and pressed against the surface of the metal sheet 2A of the sheet set 1 so that further movement of the first rigid body 12 is restricted. In the second composite electrode 20, the end surface 22a of the second rigid body 22 is firstly brought into contact with and pressed against the surface of the metal sheet 2B of the sheet set 1 so that further movement of the second rigid body 22 is restricted.

Furthermore, in the first composite electrode 10, the first electrode body 11 is continuously moved toward the metal sheet 2A. In this process, the spacing between the first rigid body 12 and the retailer plate 15 gradually decreases, and the first resilient member 13 (compression coil spring 13A) undergoes compressive deformation. Concurrently, in the second composite electrode 20, the second electrode body 21 is continuously moved toward the metal sheet 2B. In this process, the spacing between the second rigid body 22 and the retailer plate 25 gradually decreases, and the second resilient member 23 (compression coil spring 23A) undergoes compressive deformation.

Subsequently, as shown in FIG. 2B, in the first composite electrode 10, the end surface 11 as of the first electrode body 11 is brought into contact with and pressed against the surface of the metal sheet 2A so that further movement of the first electrode body 11 is restricted. Concurrently, in the second composite electrode 20, the end surface 21 as of the second electrode body 21 is brought into contact with and pressed against the surface of the metal sheet 2B so that further movement of the second electrode body 21 is restricted.

In this manner, the sheet set 1 is clamped by the first electrode body 11 and the second electrode body 21, which face each other, and by the first rigid body 12 and the second rigid body 22, which face each other. In this process, pressing forces from the first electrode body 11 and the second electrode body 21 are applied to the sheet set 1, and pressing forces from the first rigid body 12 and the second rigid body 22 are also applied to the sheet set 1.

Here, it should be noted that a resilient force due to the compressive deformation of the compressively deformed first resilient member 13 acts on the first rigid body 12, and a resilient force due to the compressive deformation of the compressively deformed second resilient member 23 acts on the second rigid body 22. As a result, the metal sheets 2A, 2B, which constitute the sheet set 1, are subjected to the application of forces not only at the contact areas with the first electrode body 11 and the second electrode body 21 but also at the surrounding, annular areas (contact areas with the first rigid body 12 and the second rigid boy 22), so that the metal sheets 2A, 2B are placed in a state of sufficient contact over a large area. Consequently, the occurrence of sheet separation is inhibited.

In this state, the power supply is driven and a current is applied across the first electrode body 11 and the second electrode body 21.

FIG. 3 is a schematic diagram illustrating a situation in which a nugget is formed by spot welding using the resistance spot welding apparatus shown in FIG. 2. In FIG. 3, the dashed arrows show the flow of the welding current.

As shown in FIG. 3, the contact area between the metal sheets 2A, 2B is not limited to the area corresponding to the areas in contact with the first electrode body 11 and the second electrode body 21 but extends over a larger area including the surrounding area corresponding to the areas in contact with the first rigid body 12 and the second rigid boy 22, unlike in cases of conventional spot welding techniques. As a result, when a current is applied across the first electrode body 11 and the second electrode body 21, the current flows over a large region within the sheet set 1, i.e., within the metal sheets 2A, 2B without causing marked sheet separation.

Specifically, the current flows not only simply from the first electrode body 11 to the second electrode body 21, but also is drawn toward the first rigid body 12 from the first electrode body 11 and then is drawn toward the second rigid body 22, and finally flows to the second electrode body 21. This is due to the sufficient contact between the metal sheets 2A, 2B at the area corresponding to the areas facing the first rigid body 12 and the second rigid body 22 by virtue of the strong forces from the first rigid body 12 and the second rigid body 22, and also due to the high electrical conductivities of both the first rigid body 12 and the second rigid body 22.

Typically, expulsion occurs between metal sheets but, in the case where a large current is applied across the electrodes, the contact areas between the electrodes and the metal sheets can become overheated, so that expulsion may occur on the surfaces of the metal sheets. In the present embodiment, by virtue of the first rigid body 12 and the second rigid body 22, which are both electrically conductive, the current from the first electrode body 11 is partially diverted to the electrically conductive first rigid body 12 or the current from the second electrode body 21 is partially diverted to the second rigid body 22, and therefore heat generation is inhibited at the contact areas between the electrodes and the metal sheets, and consequently the present embodiment provides the further advantage of inhibiting expulsion on the metal sheets.

Thus, because of the strong forces of the first rigid body 12 and the second rigid body 22 applied to the metal sheets 2A, 2B, the contact area between the metal sheets 2A, 2B is fused over a large area, so that a nugget 3 having a large nugget diameter is formed.

With the spot welding of the present embodiment, it is possible to enlarge the nugget diameter and therefore to increase the weld joint strength including the CTS. Moreover, it is possible to expand the suitable current range in association with the enlargement of the nugget diameter.

In order to produce the effect of inhibiting sheet separation, an important issue is the spacing between the outer periphery of the end surface 11aa of the first electrode body 11 and the inner periphery of the end surface 12a of the first rigid body 12 and the spacing between the outer periphery of the end surface 21aa of the second electrode body 21 and the inner periphery of the end surface 22a of the second rigid body 22. Hereinafter, the spacings are also collectively referred to as the electrode-rigid body spacing. The electrode-rigid body spacing is preferably as small as possible to the extent that the electrode body and the rigid body are not in contact with each other during welding. If the electrode-rigid body spacing is too large, the effect of inhibiting sheet separation will be reduced and, in addition, the current cannot extend easily. The electrode-rigid body spacing is preferably at most 7 mm. More preferably, the electrode-rigid body spacing is at most 5 mm, and still more preferably at most 3 mm. On the other hand, if the electrode-rigid body spacing is too small, inadvertent contact between the electrode bodies and the rigid bodies occurs to cause conduction during welding, so that the welding current becomes unstable. For this reason, the electrode-rigid body spacing is preferably not less than 0.3 mm for practical purposes. More preferably, the electrode-rigid body spacing is not less than 0.5 mm, and more preferably not less than 1.0 mm

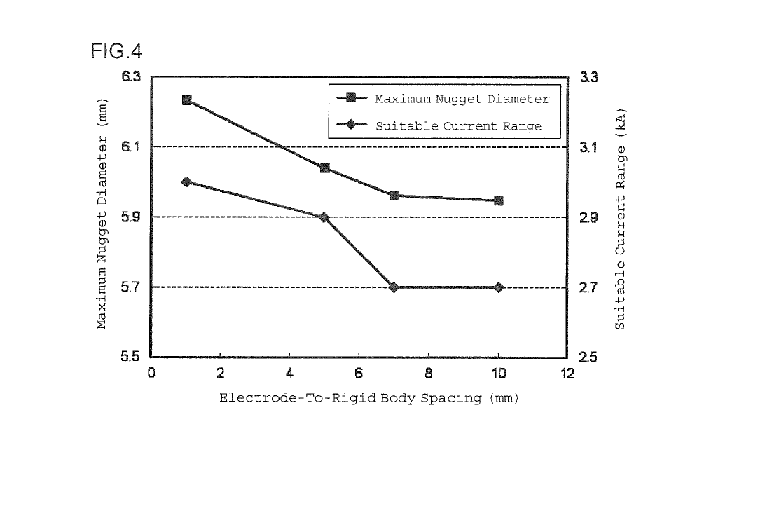

FIG. 4 is a graph showing the relationships between the electrode-to-rigid body spacing and the maximum nugget diameter and between the electrode-to-rigid body spacing and the suitable current range. The relationships shown in FIG. 4 are results from analysis of the influence of the electrode-rigid body spacing on spot welding, conducted using spot welding analysis software SORPAS (a registered trademark of SCSK Corporation). In the analysis, the conditions for extending the current from the electrode bodies toward the rigid bodies were set with various electrode-rigid body spacings. The metal sheets to be welded were hot stamped steel sheets (non-plated) having a tensile strength of 1500 MPa Grade with a thickness t of 1.2 mm. The material of the electrodes and the rigid bodies was a copper-chromium alloy (1 mass % Cr—Cu). The electrode tips of the electrode bodies were SR type electrode tips, each having an outside diameter, including that of the end surface, of 8 mm with the radius of curvature R of the end surface being 80 mm. The force applied by the electrode bodies was 3.43 kN (350 kgf) and the welding time was 16 cycles (frequency: 60 Hz). Different welding currents were used for each of the various electrode-rigid body spacings, and the resulting nugget diameter and the occurrence of expulsion were investigated for each condition.

In the investigation, the maximum nugget diameter and the suitable current range were evaluated for each of the electrode-rigid body spacings. The maximum nugget diameter was defined as the largest nugget diameter that can be obtained without causing expulsion. The suitable current range was defined as a range of current values from a current value required to obtain a nugget having a nugget diameter of 4 √t to a maximum current value up to which no expulsion occurs. From FIG. 4, it is seen that, starting from the point of the electrode-rigid body spacing of 7 mm, the maximum nugget diameter increases and the suitable current range expands with the decreasing electrode-rigid body spacing. This demonstrates that a preferred electrode-rigid body spacing is at most 7 mm.

In the spot welding apparatus of the present embodiment, the first electrode body 11 (the electrode tip 11a in particular) is surrounded by the first rigid body 12. Likewise, the second electrode body 21 (the electrode tip 21a in particular) is surrounded by the second rigid body 22. For this reason, heat generated in spot welding tends to accumulate in the first electrode body 11 and the second electrode body 21, which can shorten the lives of the electrode tips 11a, 21a. Therefore, it is desired that the first rigid body 12 and the second rigid body 22 be actively cooled to inhibit heat accumulation and that the first electrode body 11 and the second electrode body 21 be indirectly cooled. An example of the cooling structure may be such that a cooling water passage is provided within the first rigid body 12 so that cooling water is circulated through the cooling water passage. Another example of the cooling structure may be such that cooling water is sprayed on the outer peripheral surface of the first rigid body 12. In the latter case, the cooling water to be used is one containing an anti-rust agent. These cooling structures may also be employed for the second electrode body 21.

### Second Embodiment

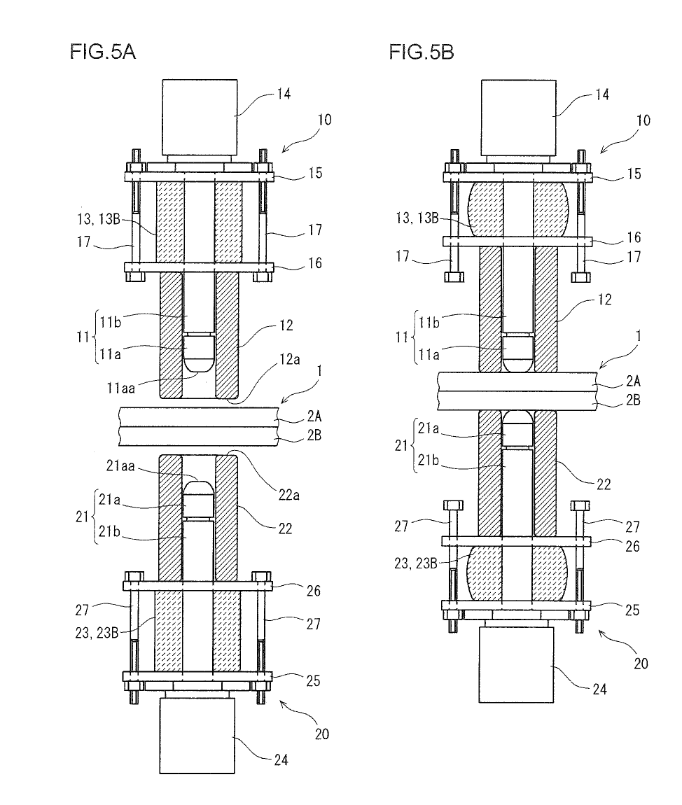

FIGS. 5A and 5B are schematic diagrams of a resistance spot welding apparatus according to a second embodiment. FIG. 5A shows a state prior to welding and FIG. 5B shows a state during welding. The spot welding apparatus according to the second embodiment shown in FIGS. 5A and 5B are based on the configuration of the spot welding apparatus according to the first embodiment shown in FIGS. 2A and 2B, and thus redundant descriptions will not be repeated where appropriate.

In the second embodiment, the shank 11b of the first electrode body 11 does not include the flange portion 11ba like the one in the first embodiment described above. Accordingly, the first rigid body 12 does not include the stopper surface 12c at its rear end portion like the one in the first embodiment described above.

The movable plate 16 is secured to the rear end of the first rigid body 12, and the retainer plate 15 is secured to the front end of the holder 14. The shank 11b of the first electrode body 11 passes through the movable plate 16 and the retainer plate 15. A cylindrical molded polymeric component 13B, employed as the first resilient member 13, is disposed between the movable plate 16 and the retainer plate 15. The shank 11b of the first electrode body 11 passes through the molded polymeric component 13B (first resilient member 13) concentrically therewith. A plurality of guide bolts 17 are screwed into a peripheral region of the retainer plate 15 so as to pass through a peripheral region of the movable plate 16. Thus, the first resilient member 13 is sandwiched and retained between the movable plate 16 and the retainer plate 15. The first rigid body 12, integrally with the movable plate 16, is relatively movable along the shank 11b by means of the guiding of the guide bolts 17.

The first rigid body 12 and the fist electrode body 11 are insulated from each other without being electrically connected. Specifically, an insulator such as an engineering plastic is disposed in the region where the first rigid body 12 and the first electrode body 11 can be directly or indirectly connected to each other. For example, the movable plate 16, which can slide against the shank 11 b, is made of an insulating material.

Likewise, the shank 21b of the second electrode body 21 in the second embodiment does not include the flange portion 21ba like the one in the first embodiment described above. Accordingly, the second rigid body 22 does not include the stopper surface 22c at its rear end portion like the one in the first embodiment described above.

The movable plate 26 is secured to the rear end of the second rigid body 22, and the retainer plate 25 is secured to the front end of the holder 24. The shank 21b of the second electrode body 21 passes through the movable plate 26 and the retainer plate 25. A cylindrical molded polymeric component 23B, employed as the second resilient member 23, is disposed between the movable plate 26 and the retainer plate 25. The shank 21b of the second electrode body 21 passes through the molded polymeric component 23B (second resilient member 23) concentrically therewith. A plurality of guide bolts 27 are screwed into a peripheral region of the retainer plate 25 so as to pass through a peripheral region of the movable plate 26. Thus, the second resilient member 23 is sandwiched and retained between the movable plate 26 and the retainer plate 25. The second rigid body 22, integrally with the movable plate 26, is relatively movable along the shank 21b by means of the guiding of the guide bolts 27.

The second rigid body 22 and the second electrode body 21 are insulated from each other without being electrically connected. Specifically, an insulator such as an engineering plastic is disposed in the region where the second rigid body 22 and the second electrode body 21 can be directly or indirectly connected to each other. For example, the movable plate 26, which can slide against the shank 21b, is made of an insulating material.

Examples of the material of the first resilient member 13 and the second resilient member 23 include a material having excellent durability and suitable resiliency such as a polyurethane resin.

During welding using the spot welding apparatus configured as described above, pressing forces are applied to the first rigid body 12 and the second rigid body 22 from the compressively deformed first resilient member 13 and second resilient member 23, i.e., the molded polymeric components 13B, 23B. This situation is the same as that in the first embodiment described above. Therefore, the second embodiment also produces advantageous effects similar to those of the first embodiment described above.

### EXAMPLES

To verify the advantages of the present invention, a welding test was conducted in which spot welding was performed using a spot welding apparatus according to the first embodiment as shown in FIG. 2. A number of sheet sets formed of two lapped steel sheets of the same grade having the same thickness, for use as test specimens, were prepared from hot stamped steel sheets (non-plated) having a tensile strength of 1500 MPa Grade with a thickness of 1.6 mm DR type electrode tips were used as the electrode tip of the first electrode body and the electrode tip of the second electrode body. The DR type electrode tips were made from a copper-chromium alloy (1 mass % Cr—Cu), having an outside diameter of 12 mm with an end diameter of 6 mm and having a radius of curvature R of the end surface of 40 mm. The first rigid body and the second rigid body were made from a copper-chromium alloy (1 mass % Cr—Cu), having an inside diameter of 13 mm

The welding conditions are shown in Table 1 below. The welding current was varied for each run of spot welding, and the behavior of the nugget growth and the current value at which expulsion occurs were investigated. In Table 1, 1 cycle indicates 1/60 seconds.

TABLE 1

| Sheet | Applied | Welding | Welding | Holding |
|---|---|---|---|---|
| thickness | force | time | current | time |
| 1.6 mm | 400 kgf | 20 cyc. | 4.0-10.5 kA | 10 cyc. |
| | (3.92 kN) | | | |

Remarks) 1 cyc. indicates 1/60 seconds

For comparison, a test was conducted in which spot welding was performed using a typical conventional method simply with a pair of electrode tips alone clamping the sheet set. The test specimens and the electrode tips were prepared in the same manner as in the above inventive example and the welding conditions were the same as in the above inventive example.

A torsion test was conducted for each sheet set that had undergone the spot welding. The nugget diameter was measured from the appearance of the nugget, which was made visible by the torsion test. Specifically, diameters of the nugget were measured in two orthogonal directions, and the average of the obtained results was designated as the nugget diameter.

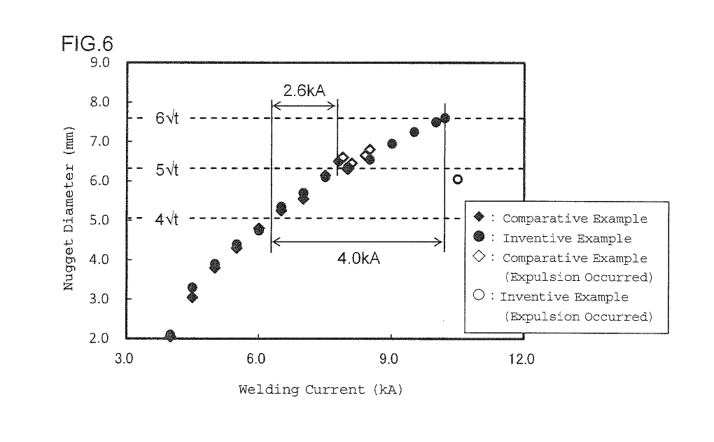

FIG. 6 is a graph showing relationships between the welding current values and nugget diameters obtained in the tests of the examples. The test specimens were prepared from hot stamped steel sheets (non-plated) of 1500 MPa Grade with a thickness t of 1.6 mm

As shown in FIG. 6, in the inventive examples, the suitable current range and the maximum nugget diameter were significantly increased than in the comparative examples. In the comparative examples, the maximum nugget diameter was approximately 5 √t, whereas, in the inventive examples, the maximum nugget diameter was greater than 6 √t. Furthermore, in the comparative examples, the suitable current range was approximately 2.6 kA, whereas, in the inventive examples, the suitable current range was expanded to approximately 4.0 kA. These results demonstrate that the present invention is capable of expanding the suitable current range and enlarging the nugget diameter in spot welding of a super high tensile steel, and therefore capable of increasing the weld joint strength.

The present invention is not limited to the embodiments described above, but may be modified in various ways without departing from the spirit and scope of the present invention. For example, the shape of the rigid bodies is not limited to cylindrical, but may be modified depending on the shape of the sheet set to be welded. That is, the shape of the rigid bodies may be such that the inner periphery of the end surface is circular and the outer periphery of the end surface is oval, elliptical, or substantially rectangular.

### INDUSTRIAL APPLICABILITY

The present invention is capable of being effectively utilized in production of structural parts from a super high tensile steel.

### REFERENCE SIGNS LIST

1: sheet set, 2A: metal sheet, 2B: metal sheet, 3: nugget,

10: first composite electrode, 11: first electrode body,

11la: electrode tip, 11aa: end surface of electrode tip,

11b: shank, 11ba: flange portion of shank,

12: first rigid body, 12a: end surface of first rigid body,

12b: through hole of first rigid body, 12c: stopper surface of first rigid body,

13: resilient member, 13A: compression coil spring,

13B: molded polymeric component, 14: holder, 15: retainer plate,

16: movable plate, 17: guide bolt,

20: second composite electrode, 21: second electrode body,

21a: electrode tip, 21aa: end surface of electrode tip,

21b: shank, 21ba: flange portion of shank,

22: second rigid body, 22a: end surface of second rigid body,

22b: through hole of second rigid body, 22c: stopper surface of second rigid body,

23: resilient member, 23A: compression coil spring,

23B: molded polymeric component, 24: holder, 25: retainer plate,

26: movable plate, 27: guide bolt.

1. A resistance spot welding apparatus for performing resistance spot welding on a sheet set including a plurality of lapped metal sheets, the apparatus comprising:
a pair of composite electrodes facing each other so as to hold the sheet set therebetween,
wherein the composite electrodes each include:
a rod-shaped electrode body having an end surface that is brought into contact with the sheet set and pressed against the sheet set;
a rigid body including an electrically conductive material being insulated from the electrode body and wherein the rigid body having a through hole in which the electrode body is inserted and having an end surface that is brought into contact with the sheet set and pressed against the sheet set; and
a resilient member coupled to a rear end of the rigid body wherein the resilient member configured to apply a pressing force to the rigid body as the electrode body and the rigid body are pressed against the sheet set.

2. The resistance spot welding apparatus according to claim 1,
wherein at least part of the end surface of the rigid body comprises an electrically conductive material.

3. The resistance spot welding apparatus according to claim,
wherein the rigid body has a cylindrical shape.

4. The resistance spot welding apparatus according to claim 1,
wherein the rigid body is configured such that an inner periphery of the end surface is circular and an outer periphery of the end surface is oval, elliptical, or substantially rectangular.

5. The resistance spot welding apparatus according to claim 1,
wherein the resilient member comprises a compression coil spring.

6. The resistance spot welding apparatus according to claim 1,
wherein the resilient member comprises a cylindrical molded polymeric component.

7. The resistance spot welding apparatus according to claim 1,
wherein a spacing between an outer periphery of the end surface of the electrode body and an inner periphery of the end surface of the rigid body is at most 7 mm.

8. The resistance spot welding apparatus according to claim 1, further comprising a cooling mechanism that cools the rigid body.

9. A composite electrode for use in resistance spot welding of a sheet set including a plurality of lapped metal sheets, the composite electrode comprising:
a rod-shaped electrode body having an end surface that is brought into contact with the sheet set and pressed against the sheet set;
a rigid body including an electrically conductive material being insulated from the electrode body and wherein the rigid body having a through hole in which the electrode body is inserted and having an end surface that is brought into contact with the sheet set and pressed against the sheet set; and
a resilient member coupled to a rear end of the rigid body wherein the resilient member configured to apply a pressing force to the rigid body as the electrode body and the rigid body are pressed against the sheet set.

10. The composite electrode according to claim 9,
wherein at least part of the end surface of the rigid body comprises an electrically conductive material.

11. The composite electrode according to claim 9,
wherein the rigid body has a cylindrical shape.

12. The composite electrode according to claim 9,
wherein the rigid body is configured such that an inner periphery of the end surface is circular and an outer periphery of the end surface is oval or substantially rectangular.

13. The composite electrode according to claim 9,
wherein the resilient member comprises a compression coil spring.

14. The composite electrode according to claim 9,
wherein the resilient member comprises a cylindrical molded polymeric component.

15. The composite electrode according to claim 9,
wherein a spacing between an outer periphery of the end surface of the electrode body and an inner periphery of the end surface of the rigid body is at most 7 mm.

16. The composite electrode according to claim 9, further comprising a cooling mechanism that cools the rigid body.

17. A method for performing resistance spot welding on a sheet set including a plurality of lapped metal sheets, the method comprising,
a first step including:
arranging a rod-shaped first electrode body and a rod-shaped second electrode body to face each other with the sheet set interposed therebetween; and
arranging a first rigid body including an electrically conductive material and a second rigid body including an electrically conductive material to face each other with the sheet set interposed therebetween, and wherein the first rigid body having a through hole in which the first electrode body is inserted and having a rear end to which a first resilient member is coupled, and wherein the second rigid body having a through hole in which the second electrode body is inserted and having a rear end to which a second resilient member is coupled,
a second step including applying a force to the sheet set by:
pressing the end surface of the first electrode body and the end surface of the second electrode body against the sheet set; and
pressing the end surface of the first rigid body and the end surface of the second rigid body against the sheet set while a pressing force from the first resilient member is being applied to the first rigid body and a pressing force from the second resilient member is being applied to the second rigid body, and
a third step including:
applying a current across the first electrode body and the second electrode body while applying the force to the sheet set.
